(19) United States
(12) Patent Application Publication
(10) Pub. No.: US 2004/0002320 A1
(43) Pub. Date: Jan. 1, 2004

(54) Square wave local oscillator technique for direct conversion receiver

(76) Inventor: Ching-Lang Lin, Plano, TX (US)

Correspondence Address: HUGHES & LUCE LLP, 1717 MAIN STREET, SUITE 2800, DALLAS, TX, 75201, US

(21) Appl. No.: 10/353,748

(22) Filed: Jan. 29, 2003

Related U.S. Application Data
(60) Provisional application No. 60/392,104, filed on Jun. 28, 2002.
(60) Provisional application No. 60/392,077, filed on Jun. 28, 2002.
(60) Provisional application No. 60/392,723, filed on Jun. 28, 2002.

(51) Int. Cl. H04B 1/26

(52) U.S. Cl. 455/318; 455/313

(57) ABSTRACT

The present invention provides a square wave local oscillator (LO) technique, applicable to devices or systems using Improved Harmonic Boosting Technique (IHBT), for achieving a DC-offset free Zero-IF signal in direct conversion receiver (DCR). A down converter using anti-parallel diode pair (APDP) cell or a modified Gilbert cell circuit mixes a received radio frequency (RF) signal with a LO signal having a square wave shape. A LO signal with a square wave-forming network provides the square wave forming circuit. A voltage control oscillator (VCO) generates a lower even order base frequency of the received RF signal.

### CROSS-REFERENCE TO RELATED APPLICATIONS

This application claims the benefit of and incorporates by reference U.S. Provisional Patent Application Serial No. 60/392,104 entitled “Square Wave Local Oscillator Technique For Direct Conversion Receiver”, filed on Jun. 28, 2002; and is related to and incorporates by reference U.S. Provisional Patent Application Serial No. 60/392,077, entitled “Harmonic Boost Signals In Up/Down Direct/Super Heterodyne Conversions For Advanced Receiver/Transmitter Architecture”, filed on Jun. 28, 2002, for Ching-Lang Lin. Additionally, this application is related to and incorporates by reference U.S. Provisional Patent Application Serial No. 60/392,723, entitled “Improved Harmonic Boost Technique For Direct Conversion Receiver”, filed on Jun. 28, 2002, for Ching-Lang Lin.

### FIELD OF INVENTION

The present invention relates to the design of direct conversion receiver circuits. More specifically, the invention relates to a direct conversion receiver circuit utilizing a square wave local oscillator that has a zero DC-offset, reduced interference and higher linearity.

### BACKGROUND OF INVENTION

With the tremendous growth of wireless communication industry, and migration to higher frequency and bandwidth, the need for better high frequency mixing techniques continues to grow significantly. As a result, sub-harmonic mixing techniques, which historically have been used for millimeter-wave applications, are no longer strangers to mainstream wireless applications such as cell phone and wireless local area network (WLAN) systems. Sub-harmonic passive mixers that exhibit excellent linearity performance are becoming even more attractive for the next generation wireless hardware. However, the difficulty of integrating passive mixers on chip remains in the requirement of high LO (local oscillator) power, which leads to significant problems through radiation and substrate coupling and increases the power consumption of the LO buffers.

Currently, most communications and semiconductor companies concentrate on implementing a direct conversion receiver (DCR)using a system On a Chip (SOC)process. However, designing a DCR using SOC (employing, for example CMOS semiconductor technology) presents severe challenges due to the existence of DC-offset and intra-chip interference. The communication industry has spent more than 50 years attempting to find better solutions to the DC-offset problem. As a result, many solutions exist with varying degrees of complexity and tradeoffs. Traditionally, the LO frequency of a DCR is the same as the receiving RF frequency, consequently the associated DC-offset results in fatal saturation of the baseband amplifiers. Additionally, the associated parasitic capacitance and inductance causes an increase in local oscillator (LO) and synthesizer leakage power which in turn leads to higher intra-chip interference. These drawbacks have become the primary obstacles in the SOC implementation of DCR today. In past years, several remedies have focused only on the second sub-harmonic operations in the converters, however, this solution still generates a large DC-offset.

### SUMMARY OF INVENTION

The present invention provides a square wave local oscillator conversion receiver that substantially eliminates or reduces disadvantages and problems associated with previously developed systems.

The present invention discusses a square wave LO that has inherent harmonic boosting properties in an improved harmonic boosting technique (IHBT) down conversion process. The square wave LO simplifies the generation of the LO frequency when compared with other IHBT systems and methods. The square wave LO maintains the IHBT's advantages of: lower LO power and conversion loss, enhanced signal strength, reduced noise figure, and linearity, while simplifying the LO frequency generation. The lowering of frequencies in the VCO and square wave-forming network circuit provide necessary solutions for obtaining zero DC-offset in DCRS. As a direct result, it makes possible the realization of this System On a Chip (SOC) chipset. Because of inherent lower intra-chip interference and lower power requirements, SOC's using this technique can integrate low noise amplifier analog baseband and down converter. This integrated SOC can significantly reduce the size of these RF systems and achieve further cost savings.

The present invention can also be implemented by providing equivalent circuits with discrete components.

One implementation has a DCR using a SOC chipset implementation or a discrete component implementation, wherein the square wave LO technique includes a VCO circuit to generate sinusoidal signal LOₑ₁. The square wave-forming network (SWFN) produces from this sinusoidal input a square wave LO output of identical frequency. This square wave LO output serves inputs to a down converter. The down converter, being an APDP circuit, a modified Gilbert circuit, or other like circuit as known to those skilled in the art, mixes a received RF signal with the square wave LO to produce a zero intermediate frequency (zero-IF) signal. The zero-IF signal output can be for I-Channel or Q-Channel. Because of zero DC-offset in the DCR utilizing the technology of the present invention, the need for a big DC-offset isolation capacitor is eliminated and the zero-IF output signal of the DCR is boosted in level.

Throughout this disclosure, LOₑ₁ equals the carrier frequency divided by 2n, where n equals one of 1, 2, 3, 4, etc.

The square wave LO technique can be individually applied with discrete devices in a DCR such as that appear below. In one implementation of a square wave-forming network device, the square wave-forming network circuit produces the same frequency square wave LO as the frequency LOₑ₁. The down converter circuit that includes an APDP cell or a modified Gilbert cell circuit and an integrated square wave-forming network circuit may also be implemented as a discrete device. The SWFN circuit produces the same frequency square wave LO as the frequency LOₑ₁. Along with the SWFN, an integrated APDP circuit or a modified Gilbert circuit is used as a down converter, wherein the down converter mixes a received RF signal with the LO frequency, producing a zero-IF signal output. The zero-IF signal output can be for I-Channel or Q-Channel and the zero-IF output signal of the DCR is boosted in level.

In one implementation, the SWFN is integrated with a VCO circuit, wherein the VCO generates a sinusoidal output LOₑ₁ coupled to the input of the SWFN circuit. The SWFN circuit produces the same frequency square wave LO as the frequency LOₑ₁.

### BRIEF DESCRIPTION OF THE DRAWING

For a more complete understanding of the present invention and the advantages thereof, reference is now made to the following description taken in conjunction with the accompanying drawings in which like reference numerals indicate like features and wherein:

FIG. 1 provides a schematic diagram of one embodiment of the present invention;

FIG. 2 depicts a schematic diagram of a square wave-forming network device as discrete component applications in a DCR based on the square wave LO technique of the present invention;

FIG. 3 illustrates a schematic diagram of a down converter device and square wave-forming network device as discrete component applications in a DCR based on the square wave LO technique of the present invention; and

FIG. 4 describes a schematic diagram of a square wave-forming network device as discrete component applications in a DCR based on the square wave LO technique of the present invention.

### DETAILED DESCRIPTION OF PREFERRED EMBODIMENTS

Preferred embodiments of the present invention are illustrated in the FIGUREs, like numerals being used to refer to like and corresponding parts of the various drawings.

The present invention provides an enhanced Improved Harmonic Boosting Technique (IHDT) for direct conversion receiver design while maintaining advantages of other implementations of IHBTs. The present invention eliminates the requirement of a digital synthesizer (or frequency multiplier) and combiner (or adder) circuits to generate local oscillator signals. The present invention has application in a wide variety of communication systems, including but not limited to wireless, satellite, radar, microwave, and radio DCRs.

In IHBTs, LO signal comprises a lower even-order frequency of the carrier frequency RF, and its multiple odd-order harmonic frequencies. Hence, the LO of the IHBT has the inherent advantages of operating at lower frequencies and lower power. Therefore, by not using the traditional higher frequencies for the LO, the present invention eliminates the generating of DC-offsets, high frequency coupling issues, and reduces intra-chip interference. The present invention makes the implementation of SOC for DCR even easier when compared to other IHBTs. The present invention provides a solution to current bottlenecks in the development of an SOC implementation of a DCR. Using this technique, DCR has lower noise figures and lower overall power consumption. This is particularly useful in wireless devices such as current and future communications systems using standards such as GSM, GPRS, cdma2000, WCDMA, DCS, blue tooth, and others.

The present invention generates a square wave shaped LO frequency rather than a sinusoidal waveform. A square wave comprises all odd-order harmonic frequencies, as required by IHBT designs. Thus, a SWFN can replace the synthesizer and combiner in an IHBT down conversion circuit. As fewer components are required and integration is reduced, the present invention simplifies the implementation of SOC for DCR using IHBT. Furthermore, the resulting DCR maintains a lower noise figure and lower overall power consumption.

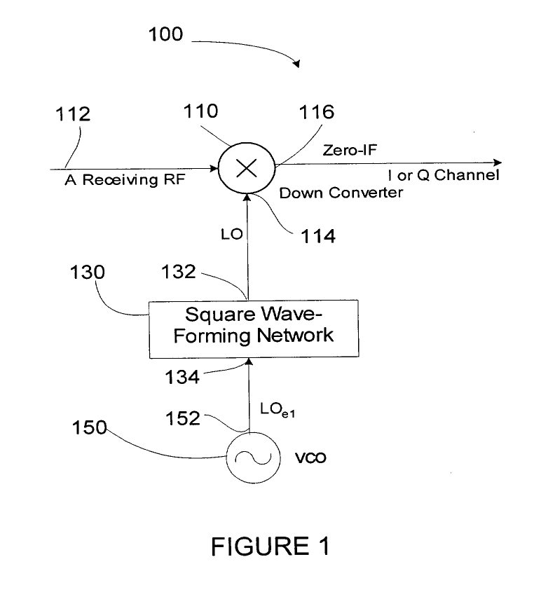

FIG. 1 shows a block diagram of a DCR constructed according to the present invention. VCO circuit 150 generates a signal at output port 152 having frequency LOₑ₁. Output port 152 connects to input port 134 of a SWFN circuit 130. The SWFN circuit 130 produces a square wave at output port 132 having a fundamental frequency of LOₑ₁. Output port 132 connects to input port 114 of down converter 110. An APDP cell, modified Gilbert cell, or other similar circuit as known to those skilled in the art functions as down converter 110. Down converter 110 acts to mix a received RF signal at input port 112 with the LO frequency at port 114 to produce a zero-IF signal at output port 116. Additionally, by using the square wave LO technique as described above in a DCR, one can achieve a boost of the zero-IF output signal of the DCR.

In FIG. 1 and subsequent FIGURES, LOₑ₁ is defined as the radio frequency of the receiver (RF) divided by 2n, where n equals one of 1, 2, 3, 4, etc.

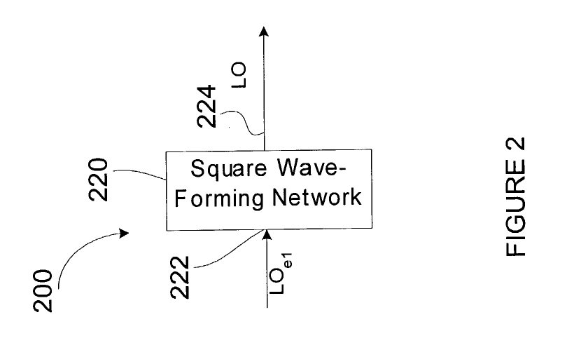

Alternatively, the present invention, shown in FIG. 2 can be implemented with the SWFN device 200 constructed as a discrete component for use in a DCR. SWFN 220 measures a frequency LOₑ₁ at input port 222. SWFN 220 produces a square wave signal LO at output port 224 having the same frequency as LOₑ₁ for the down converter.

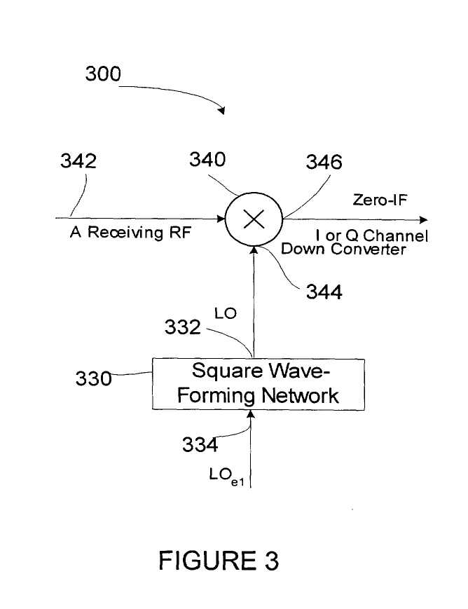

FIG. 3 depicts a down converter device implemented as a discrete component in a DCR. Down converter device 300 includes an APDP cell or a modified Gilbert cell circuit 340 integrated with a SWFN circuit 330. SWFN 330 receives a signal of frequency LOₑ₁ at input port 334, and produces a square wave LO at output port 332. The square wave signal LO at output port 332 has the same fundamental frequency as LOₑ₁. Output port 332 electrically connects to input port 344 of down converter 340. An APDP cell or a modified Gilbert cell circuit functions as down converter circuit 340. The down converter mixes a received radio frequency signal RF at port 342 with the LO frequency at port 344 to produce a zero-IF signal output at port 346. The zero-IF signal output can be for I-Channel or Q-Channel.

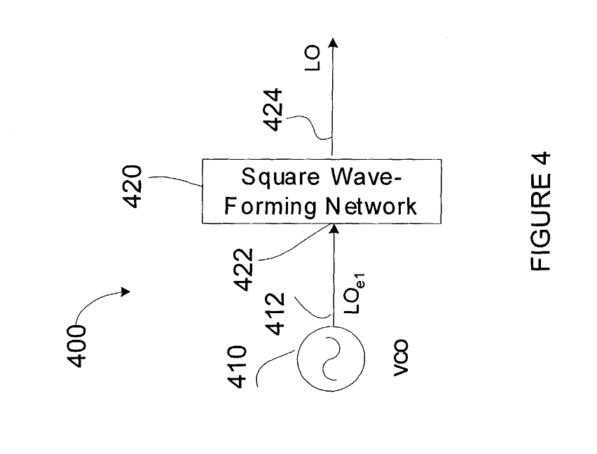

FIG. 4 depicts a square wave-forming device 400 integrated with a VCO circuit to form a single discrete component within a DCR. VCO circuit 410 generates a frequency at output port 412 having frequency LOₑ₁. Output port 412 electrically connects to input port 422 of SWFN 420. SWFN 420 produces a square wave LO at output port 424 having the same fundamental frequency as LOₑ₁.

The present invention can be further described as a direct conversion receiver. This DCR includes a voltage controlled oscillator (VCO) that generates an output port signal at a frequency equal to the carrier frequency of the receiver divided by 2n, where n equals one of 1, 2, 3, 4, etc. The output port of the voltage controlled oscillator is connected to the input port of a SWFN circuit. The SWFN produces a square wave having the same fundamental frequency as the frequency output from the VCO. The square wave output inputs to a down converter. The down converter contains an APDP cell, a modified Gilbert cell or other like circuit. The down converter mixes a received RF signal with the square wave from the SWFN circuit to produce a zero-IF signal output. The zero-IF signal output can be for I-Channel or Q-Channel.

The present invention eliminates the need for a big DC-offset isolation capacitor in I-Channel and Q-Channel when using a DCR. Additionally, a Modem attached to a DCR designed according to the system and method of the present invention need not employ a DC-offset cancellation algorithm.

In another embodiment of the present invention, reversely processing as described above can be applied to an up-converter and a direct conversion transmitter (DCT). This DCT includes a voltage controlled oscillator (VCO) that generates an output port signal at a frequency equal to the carrier frequency of the transmitter divided by 2n, where n equals one of 1, 2, 3, 4, etc. The output port of the voltage-controlled oscillator is connected to the input port of a SWFN circuit. The SWFN produces a square wave having the same fundamental frequency as the frequency output from the VCO. The square wave output inputs to an up converter. The up converter contains an APDP cell, a modified Gilbert cell or other like circuit. The up converter mixes a transmitted RF signal with the square wave from the SWFN circuit to produce a zero-IF signal output.

The present invention eliminates the need for a big DC-offset isolation capacitor in I-Channel and Q-Channel when using a DCT. Additionally, a Modem attached to a DCT designed according to the system and method of the present invention need not employ a DC-offset cancellation algorithm.

Although the invention herein has been described with reference to particular embodiments, it is to be understood that these embodiments are merely illustrative of the principles and applications of the technique of the invention. It is therefore to be understood that numerous modifications may be made to the illustrative embodiments and that other arrangements may be devised without departing from the spirit and scope of the present invention as described in this disclosure.

What is claimed is:

1. A square wave local oscillator method for a direct conversion receiver that comprises the steps of:
generating an output with a voltage-controlled oscillator (VCO), wherein the VCO generates sinusoidal output LOₑ₁;
producing a square wave output with a frequency identical to that of sinusoidal output LOₑ₁ with a square wave-forming network;
inputting said square wave LO output into a down converter;
mixing a received RF signal with square wave LO to produce a zero intermediate frequency signal in said down converter.

2. The method of claim 1, wherein LOₑ₁ equals a carrier frequency divided by 2n, where n equals one of 1, 2, 3, 4, etc.

3. The method of claim 1, wherein said down converter comprises an APDP circuit or a modified Gilbert circuit.

4. The method of claim 1, wherein said zero-IF signal output is I-Channel or Q-Channel.

5. The method of claim 1, wherein the harmonic boosting technique can be applied with separate discrete devices in a direct conversion receiver.

6. The method of claim 1, wherein the harmonic boosting technique can be applied with separate discrete devices in a direct conversion receiver using a System On a Chip chipset.

7. The method of claim 6, wherein said a system On a Chip is manufactured using CMOS semiconductor technology.

8. The method of claim 7, wherein said separate discrete devices comprise said VCO that generates an output LOₑ₁ frequency which is a carrier frequency divided by 2n, where n equals one of 1, 2, 3, 4, etc.

9. The method of claim 7, wherein said separate discrete devices comprise said down converter, and wherein said down converter contains an APDP cell or a modified Gilbert cell circuit and an integrated square wave-forming network circuit.

10. The method of claim 7, wherein said separate discrete devices comprise said square wave-forming network.

11. The method of claim 7, wherein said separate discrete devices comprise said VCO that generates an output LOₑ₁ frequency which is a carrier frequency divided by 2n, where n equals one of 1, 2, 3, 4, etc. and said down converter, wherein said down converter contains an APDP cell or a modified Gilbert cell circuit and an integrated square wave-forming network circuit.

12. A square wave local oscillator apparatus for a direct conversion receiver that comprises:
a voltage controlled oscillator (VCO), wherein the VCO generates sinusoidal output LOₑ₁;
a square wave-forming network that produces a square wave output with a frequency identical to that of sinusoidal output LOₑ₁;
a down converter that receives said square wave LO output and mixes a received RF signal with square wave LO to produce a zero intermediate frequency signal.

13. A square wave local oscillator technique for a direct conversion transmitter that comprises the steps of:
generating an output with a voltage controlled oscillator (VCO), wherein the VCO generates sinusoidal output LOₑ₁;
producing a square wave output with a frequency identical to that of sinusoidal output LOₑ₁ with a square wave-forming network;
inputting said square wave LO output into an up converter;
mixing a received RF signal with square wave LO to produce a zero intermediate frequency signal in said up converter.

14. The method of claim 13, wherein LOₑ₁ equals a carrier frequency divided by 2n, where n equals one of 1, 2, 3, 4, etc.

15. The method of claim 13, wherein said up converter comprises an APDP circuit or a modified Gilbert circuit.

16. The method of claim 13, wherein said zero-IF signal output is I-Channel or Q-Channel.

17. The method of claim 13, wherein the harmonic boosting technique can be applied with separate discrete devices in a direct conversion transmitter.

18. The method of claim 13, wherein the harmonic boosting technique can be applied with separate discrete devices in a direct conversion transmitter using a System On a Chip chipset.

19. A square wave local oscillator apparatus for a direct conversion transmitter that comprises:
a voltage controlled oscillator (VCO), wherein the VCO generates sinusoidal output LOₑ₁;
a square wave-forming network that produces a square wave output with a frequency identical to that of sinusoidal output LOₑ₁;
an up converter that receives said square wave LO output and mixes a received RF signal with square wave LO to produce a zero intermediate frequency signal.
